(19) United States
(12) Patent Application Publication
(10) Pub. No.: US 2021/0408512 A1
(43) Pub. Date: Dec. 30, 2021

(54) Vehicle dashboard built-in battery jumper rack

(71) Applicant: Mohamed Bayoumi Mahmoud Abuelazm, San Diego, CA (US)

(72) Inventor: Mohamed Bayoumi Mahmoud Abuelazm, San Diego, CA (US)

(21) Appl. No.: 16/946,537

(22) Filed: Jun. 25, 2020

(51) Int. Cl. H01M 2/10; B60R 11/02; B60R 16/03

(52) U.S. Cl. CPC H01M 2/1083; B60R 2011/0005; B60R 16/03; B60R 11/0241

(57) ABSTRACT

Vehicle dashboard built-in battery jumper rack provides a more convenient way to jump start any kind of vehicles' batteries through a connection rack built into the dashboard. The rack is connected internally to the vehicle main battery through electric cables, and includes sockets to be connected externally to the designated removable Li-ion battery pins. This eliminates the need to step out of the vehicle and opening the hood, the whole jump-starting process is completely done while the driver is inside the cabin.

### CROSS REFERENCE TO RELATED APPLICATIONS

Not applicable to this application.

### STATEMENT REGARDING FEDERALLY SPONSORED RESEARCH OR DEVELOPMENT

Not applicable to this application

### DESCRIPTION OF THE INVENTION

A connection rack including 2 connection sockets (different sizes to prevent wrong installment) is to be installed into an appropriately insulated cavity within the vehicle dashboard, and connected internally to the vehicle main battery through electric cables running from the back of the rack behind the dashboard to under the hood where it connects to the vehicle main battery via 2 electrodes attached to the battery terminals. This eliminates the need to step out of the vehicle and opening the hood, it is completely done while the driver is inside the passengers cabin (FIG. 1).

A removable Lithium-ion (acting as the jump starting power source) with 2 battery connection pins (different sizes to prevent wrong installment) that fits into the rack connection sockets. This ensures a safe electrical connection between the rack and the removable Li-ion battery (FIG. 1).

Removable Li-ion battery casing wrong installment prevention groove that fits on a protruded line inside the rack casing (FIG. 1).

### DESCRIPTION OF THE DRAWING

FIG. 1: An inside view of a vehicle's cabin and dash board showing the removable Li-ion battery with the 2 designated connection pins (different sizes to prevent wrong installment) that would fit into the connection sockets (different sizes to prevent wrong installment) of the connection rack which is installed into an appropriately insulated cavity within the vehicle dashboard, and connected internally to the vehicle main battery through electric cables running from the back of the rack behind the dashboard to under the hood where it connects to the vehicle main battery via 2 electrodes attached to the battery terminals.

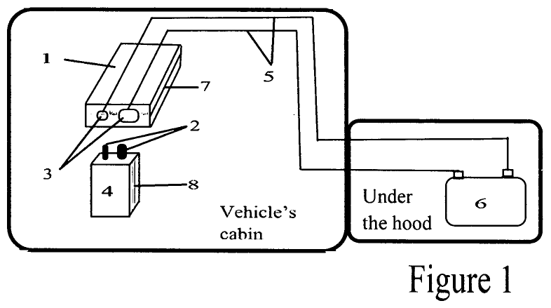

### LABELLINGS OF THE DRAWING

Illustration diagram is labelled according to the following numbering code:
1—Connection rack
2—Connection pins
3—Connection sockets
4—Removable Li-ion battery
5—Connection cables and terminals
6—Main vehicle battery
7—Protruded line inside the rack casing
8—Battery casing wrong installment prevention groove

I claim:

1- A vehicle dashboard built-in connection rack including 2 connection sockets for the removable Li-ion battery pins, and cables to the main battery.
